(19) United States
(12) Patent Application Publication
(10) Pub. No.: US 2026/0131556 A1
(43) Pub. Date: May 14, 2026

(54) COATED BARRIER FABRIC WITH IMPROVED TEAR STRENGTH FOR A REUSABLE PERSONAL PROTECTIVE EQUIPMENT PRODUCT

(71) Applicant: Standard Textile Co., Inc., Cincinnati, OH (US)

(72) Inventors: Richard M. Holbert, JR., Loveland, OH (US); Sara Arvidson Broadaway, Woodruff, SC (US)

(21) Appl. No.: 19/385,209

(22) Filed: Nov. 11, 2025

Related U.S. Application Data
(60) Provisional application No. 63/719,247, filed on Nov. 12, 2024.

(51) Int. Cl. B32B 5/26; B32B 5/02; B32B 27/08; B32B 27/34; B32B 27/36; B32B 37/24

(52) U.S. Cl. CPC B32B 5/263; B32B 5/024; B32B 27/08; B32B 27/34; B32B 27/36; B32B 2037/243; B32B 2250/02; B32B 2250/24; B32B 2255/02; B32B 2255/26; B32B 2307/558; B32B 2307/7265; B32B 2437/00

(57) ABSTRACT

A coated barrier fabric for use in a reusable personal protective equipment product is provided that has two woven, knitted, or non-woven plies. Each of the plies are coated on one side with a non-fluorine containing polymer and retain similar comfort and feel of uncoated fabrics. The coated sides of the plies face each other in the interior of the barrier fabric and can move freely thereagainst. One of the plies can be rotated relative to the other such that the warp (or machine) direction of one of the plies is situated perpendicular (90°) to the warp (or machine) direction of the other ply to provide a crisscross type configuration. This 90-degree orientation improves the overall tear strength of the barrier fabric allowing the product to withstand up to 50+ industrial wash/dry/autoclave cycles. The useful life of the product can be extended while simultaneously allowing for optimized lower fabric weight to improve comfort.

### TECHNICAL FIELD

This application relates generally to barrier fabrics and, more specifically, to coated barrier fabrics for use in reusable personal protective equipment (PPE) products, such as reusable military or medical products, including surgical gowns or drapes.

### BACKGROUND

Barrier fabrics are generically characterized as being resistant to penetration by liquids. Because of this property, barrier fabrics are especially suited for use in the military and medical field to prevent or control the spread of infectious microorganisms, such as viruses and bacteria found in blood, and other potentially infectious material (“OPIM”) associated with, for example, surgical procedures.

Barrier fabric properties are critical for military and medical products such as surgical drapes that are used to maintain sterile surgical or procedure fields and other personal protective equipment (PPE) or apparel such as surgical or isolation gowns. Particularly where there is a possibility of coming into contact with bodily fluids, every effort is made to protect the health professional and the patient. Health professionals, including those in the military, routinely use medical barrier fabrics during surgery, the drawing of blood, or while working with specimens containing contaminated fluids to both protect themselves and to avoid cross or secondary contamination of subsequent patients through the inadvertent transmission of infectious materials.

Personal protective garments made from barrier fabrics typically are manufactured using the same construction techniques as other garments worn by individuals. The grain or machine direction is consistent throughout the entire garment to maintain grain integrity, structural stability, and overall garment appearance. These construction techniques prevent twisting and puckering of the seams.

Generally, there are two types of medical barrier fabrics: (1) single use, i.e., disposable, fabrics, and (2) reusable fabrics. Performance of the single use or disposable fabrics in terms of liquid resistance is generally acceptable; however, these fabrics often fail to provide the spectrum of properties deemed necessary to achieve desirable protection in many medical applications. Additionally, single use items contribute significantly to the volume of medical waste and are inconsistent with accepted principles of environmental sustainability. Reusable medical barrier fabrics, on the other hand, can offer equivalent or better performance with respect to liquid resistance, better fabric drape, wearer comfort, and lower cost per use. However, it is also known that reusable barrier fabrics are commonly associated with diminished protective performance over the course of the usable service life.

Importantly, reusable medical gowns, surgical drapes, and other non-disposable medical barrier fabric products have requirements that distinguish them from other products or garments that incorporate barrier fabrics. To wit, after each use, a reusable surgical gown, for example, must be washed, dried, and sterilized for subsequent reuse. These procedures often involve harsh detergents and high temperatures which can quickly degrade the barrier properties of the gown and limit the number of times the gown can be reused.

A typical, institutional laundering (i.e., washing and drying)/autoclaving cycle for such reusable medical products generally comprise one or more initial flushes in which the products are soaked in water at 90°−100° F. for two to five minutes. Following the one or more flushes, the products are soaked in an alkali bath at approximately 120°-160° F. for three to ten minutes to loosen dirt. Next the products are placed in a detergent bath at approximately 160° F. for approximately five to ten minutes. This is followed by one or more rinsings at temperatures that may be progressively reduced from about 140° F. to ambient temperature. The products are mechanically agitated in some, if not all of these baths. Also, following each bath, there is a drain to minimize the liquid carried over to the succeeding process. Finally, there is an acid sour bath in which the pH is adjusted to the 4.0 to 7.0 range, and in which a softening agent may also be employed. After washing, the products are extracted (spin or hydraulic press) to remove as much water as possible prior to drying. The products are then dried in a tumbling dryer at an average temperature of 160° F. Typical drying times for products are in the order of 15 to 30 minutes. It is to be noted that there can be hot spots in such dryers, which can subject the products to temperatures in excess of 400° F. After drying, the products are placed in an autoclave and sterilized by pressurized steam at a temperature of approximately 270° F. for at least four minutes in a commercially available pre-vacuum steam sterilizer. Parameters for sterilization will differ for a gravity steam sterilizer.

These harsh conditions are several orders of magnitude greater than those that exist in the laundering or dry cleaning of barrier fabrics incorporated in ordinary garments. In fact, many of the barrier fabrics intended for use in normal (e.g., non-medical) garments, such as foul weather gear, become unusable after a single, or relatively few, institutional laundering/autoclaving cycles.

While the efforts to produce reusable barrier fabrics with required liquid and microorganism resistance for use in medical applications have seen some success, fabric coatings known in the art tend to degrade the feel of the fabric and give the coated fabric a rubberized finish, which is not appealing for many fabric uses, particularly garments. Moreover, heavy abrasion or multiple harsh institutional laundering/autoclave cycles often result in breakdowns in the protective properties of some known reusable barrier fabrics, which can significantly shorten the potential useful life of the fabrics. Still further, a technique to minimize the cost of manufacture of the barrier fabric is to weave an unbalanced construction related to the ends per inch and the pick per inch, for example. By weaving fewer picks per inch than ends per inch, the fabric costs less to manufacture. However, the unbalanced density results in unbalanced fabric strength and these barrier fabrics can fail minimum tear strength requirements for personal protective equipment and surgical gowns (e.g., ASTM F2407) in the healthcare industry/in healthcare facilities after only 35 wash, dry, autoclave cycles or less.

It thus would be beneficial to provide an improved coated barrier fabric for use in a reusable personal protective equipment products, such as reusable military and medical products, including surgical gowns or drapes, that can achieve excellent liquid resistance without sacrificing the comfort or the feel of the fabric while minimizing the cost of manufacture but sustain said barrier properties and further provide a desirable tear strength even after 50 (or more) institutional laundering/autoclaving cycles.

### SUMMARY

The present invention relates generally to barrier fabrics and, more specifically, to coated barrier fabrics for use in reusable personal protective equipment products, such as reusable military or medical products, including surgical gowns or drapes.

In one embodiment, a coated barrier fabric for use in a reusable PPE product (e.g., a surgical gown or surgical drape) is provided and has two woven, knitted, nonwoven, or other fabric plies. Each of the two plies are coated on one side with a non-fluorine containing polymer and retain similar comfort and feel of uncoated woven or knitted fabrics. The coated sides of the plies face each other (i.e., inwardly) in the interior of the barrier fabric. Because of the orientation of the plies, the coated sides of the plies can come into direct contact with and move freely against each other within the interior of the barrier fabric. The coating on each of the plies is protected from exterior and environmental factors, including repeated institutional laundering/autoclave cycles, that could abrade and degrade the coating. One of the two plies can be rotated relative to the other ply such that the warp (machine) direction (e.g., warp yarns of a woven fabric) of the one ply are situated perpendicular (i.e., at a 90-degree rotation) to the warp (machine) direction (e.g., warp yarns of a woven fabric) of the other ply to provide a crisscross type configuration. This warp (machine) direction (e.g., warp yarn) perpendicular orientation improves the overall tear strength of the barrier fabric allowing the reusable medical product to withstand up to 50 or more industrial wash/dry/autoclave cycles. Thus, the useful life of the reusable medical product including the barrier fabric can be extended.

In another embodiment, a barrier fabric is provided that includes a first ply and a second ply each comprising a coated side and a non-coated side wherein the first ply and the second ply are peripherally joined together to form the barrier fabric, and wherein a machine direction of the first ply or second ply is rotated 90 degrees relative to a machine direction of the other ply to define a perpendicular orientation with respect to the yarns or fiber content in the first and second plies and provide a crisscross type configuration. In one example, the coated side of the first ply and the coated side of the second ply face each other and define an interior of the barrier fabric, with each coated side able to come into direct contact with one another but remain movable thereagainst and able to form a gap therebetween, and the non-coated side of the first ply and the non-coated side of the second ply face opposing directions and define an exterior of the barrier fabric.

In another embodiment, a reusable personal protective equipment product is provided that includes a two-ply barrier fabric, the fabric including a first ply and a second ply each comprising a coated side and a non-coated side wherein the first ply and the second ply are peripherally joined together to form the barrier fabric, and wherein a machine direction of the first ply or second ply is rotated 90 degrees relative to a machine direction of the other ply to define a perpendicular orientation with respect to the yarns or fiber content in the first and second plies and provide a crisscross type configuration. In one example, the coated side of the first ply and the coated side of the second ply face each other and define an interior of the barrier fabric, with each coated side able to come into direct contact with one another but remain movable thereagainst and able to form a gap therebetween, and the non-coated side of the first ply and the non-coated side of the second ply face opposing directions and define an exterior of the barrier fabric.

In yet another embodiment, method for making a two-ply barrier fabric for use in a reusable personal protective equipment product includes applying, via at least one pass, a non-fluorine containing pre-polymer, polymer, or monomer coating material to a side of each of two separate plies of a non-woven, woven, or knitted fabric, wherein the coating is applied at a rate of from 1 g/m² to 75 g/m² and curing the coating on the fabric. Next, the coated first ply and second ply to form the barrier fabric are peripherally joining together wherein a machine direction of the first ply or second ply is rotated 90 degrees relative to machine direction of the other ply to define a perpendicular orientation with respect to the yarns or fiber content in the first and second plies and provide a crisscross type configuration; and wherein the barrier fabric is suitable for use within or as a reusable personal protective equipment product. In one example, the coated side of the first ply and the coated side of the second ply face each other and define an interior of the barrier fabric, with each coated side able to come into direct contact with one another but remain movable thereagainst and able to form a gap therebetween, and the non-coated side of the first ply and the non-coated side of the second ply face opposing directions and define an exterior of the barrier fabric.

### BRIEF DESCRIPTION OF THE DRAWINGS

The accompanying drawings, which are incorporated in and constitute a part of this specification illustrate embodiments of the invention and, together with the general description of the invention given above and the detailed description given below, serve to explain the principles of the invention. Similar reference numerals are used to indicate similar features throughout the various figures of the drawings.

FIG. 1 is a front elevational view of a surgical gown, which includes a coated barrier fabric, in accordance with an embodiment of the present invention;

FIG. 2 is an enlarged, fragmentary top plan view of the incircle portion 2 of the gown of FIG. 1 showing a coated barrier woven fabric;

FIG. 3A is a cross-sectional view of a portion of the gown of FIG. 1, showing a gap between the plies of the coated fabric of the gown;

FIG. 3B is a cross-sectional view of a portion of the gown of FIG. 1 similar to FIG. 3A, but showing no gap between the plies of the coated fabric of the gown;

FIG. 4 is a graph illustrating the relationship between warp and weft tear strength for multiple samples subjected to wash/dry/autoclave cycles in which the resulting slope is equal to 1.5;

FIGS. 5 and 6 are graphs illustrating the weft and warp tear strength, respectively, for multiple samples at various wash/dry/autoclave cycles, including the effects of a 90-degree rotation of one ply layer relative to the other; and

FIGS. 7 and 8 are graphs illustrating the weft and warp tear strength, respectively, for multiple samples at various wash/dry/autoclave cycles, including the effects of a 90-degree rotation of one ply layer relative to the other.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, this Detailed Description is not meant to limit the scope of the present disclosure.

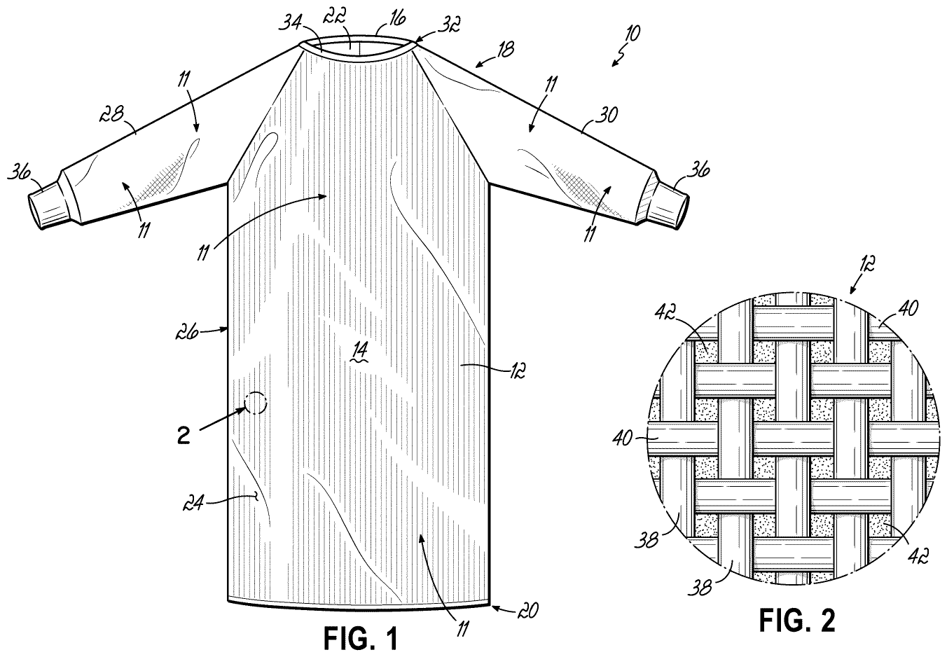

FIGS. 1 through 3B show a reusable surgical gown 10, or portions thereof, in accordance with an embodiment of the present invention. At least some portions of the gown 10, are fabricated from a coated, two-ply barrier fabric 12. The fabric 12 offers a reliably durable and effective liquid barrier without sacrificing comfort or feel (as known coated or laminated barrier fabrics in the art do) due to the fabric's 12 coated two-ply construction. Moreover, due to a perpendicular orientation of the warp (machine) direction 38, here warp yarns 38, in one ply 44, 46 relative to the warp (machine) direction, here warp yarns 38 of the other ply 44, 46, the two-ply barrier fabric 12 exhibits durability to withstand repeated institutional laundering/autoclave cycles (e.g., up to 50 or more cycles) while minimizing manufacturing cost and maintaining effective liquid barrier properties. Other advantages and technical effects of the embodiments of this invention will become evident to one skilled in the art from the following description.

Use of descriptive terms hereinbelow such a left, right, top, bottom, front, back, or vertical as the terms pertain to or describe the gown 10 are to be interpreted from the viewpoint of a wearer of the gown 10, when properly donned, unless otherwise noted.

With specific reference to FIG. 1, the reusable surgical gown 10 generally includes a front 14 and an optional back 16, a top 18 and a bottom 20, and an inner surface 22 and an outer surface 24. The gown 10 also includes a central body 26 and a pair of opposing long sleeves, i.e., right sleeve 28 and left sleeve 30. Each of the sleeves 28, 30 are located adjacent to and extend in a direction away from a neck opening 32. The neck opening 32 is generally defined by the top edge 34 of the central body 26. Further, the sleeves 28, 30 each have an optional terminal cuff 36. The sleeves 28, 30 may be joined to the central body 26 and the cuffs 36 may be joined to their respective sleeves 28, 30 by techniques known in the art, such as by sewing.

One or more of the terminal cuffs 36, in other embodiments, may be absent altogether, with the long sleeves 28, 30 simply defining an opening that is hemmed at a distal end of each sleeve 28, 30. In another example, the long sleeves 28, 30 may be short sleeves or they may be no sleeves at all, if so desired. In other embodiments, the terminal cuff 36 may be replaced with long sleeves 28, 30 having thumb loops, for example. Moreover, although the central body 26 and the sleeves 28, 30 are shown as one piece in FIG. 1, it should be appreciated that the central body 26 or sleeves 28, 30 could be formed of multiple fabric pieces stitched or fastened together, or the like, by means known in the art.

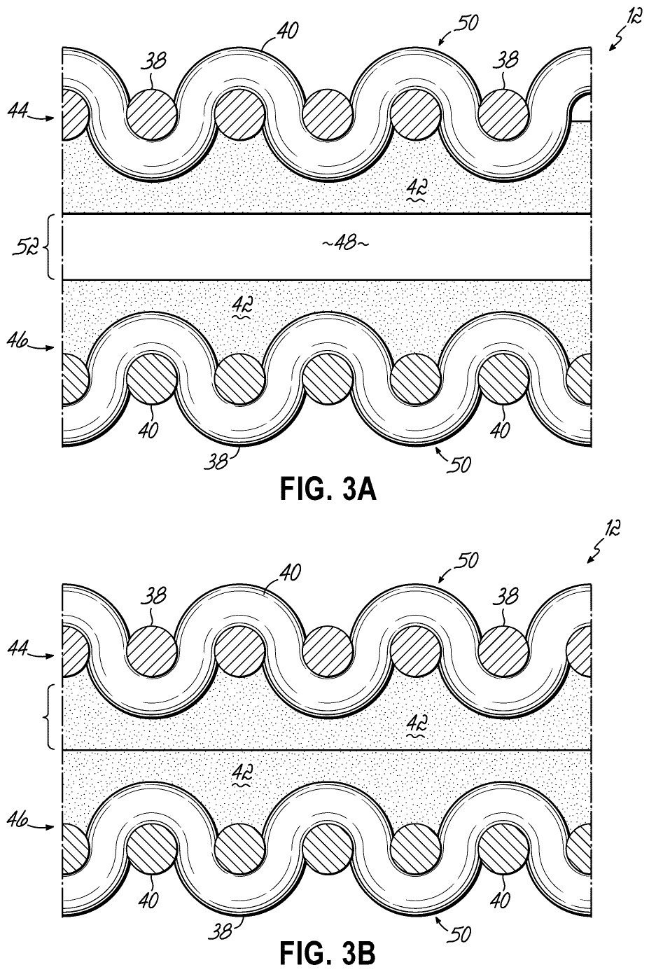

Still referring to FIG. 1, at least some portions of the gown 10, such as certain critical zones 11, can be fabricated from the coated, two-ply barrier fabric 12. The construction and composition of the fabric 12 is further described below in relation to FIGS. 2-3B. As used herein, a critical zone 11 is an area of a medical product, such as a gown or drape, where the product is most likely to come into direct contact with potentially infectious material. According to the Association for the Advancement of Medical Instrumentation (“AAMI”) PB70 Standard, the critical zone 11 of a surgical gown, such as the gown 10 depicted in FIG. 1, are, at minimum, the front of the gown from chest to knees and the sleeves of the gown from the cuff to above the elbow.

It will be appreciated that alternative embodiments can take forms other than a reusable surgical gown 10. For example, the fabric 12 may be alternatively embodied in other reusable personal protective equipment products, such as reusable military and medical products, including a surgical drape, stand or table covers, wrappers, or other protective apparel. In the case of an isolation gown, the AAMI PB70 Standard dictates that the critical zones 11 are the entire gown, including the seams, but excluding the cuffs, hems, and bindings. In the case of a surgical drape, the critical zone 11 can be defined as the area of the drape generally surrounding the fenestration. Regardless of the embodiment, it is to be understood that the critical zones 11 of embodiments (e.g., gowns, drapes, etc.) may be fabricated from a coated, two-ply barrier fabric 12. However, the fabric 12 may be used in other embodiments (besides in the critical zones 11 of gowns and drapes). In this way, the fabric 12 is not limited in use to any specific reusable military or medical product.

Referring now to FIG. 2, the figure shows an enlarged view of a portion of the reusable surgical gown 10 of FIG. 1. Specifically, FIG. 2 shows one ply 44, i.e., a top or outer ply, of the fabric 12 that is used to fabricate at least the critical zones 11 of the gown 10. In the embodiment depicted in FIG. 2, the fabric 12 is defined by a woven web of warp yarns 38 and fill (or weft) yarns 40. In an embodiment, at least some of the yarns are multifilament yarns, though other yarns (e.g., monofilament) may be used. In an alternative embodiment, the fabric 12 may be knitted, non-woven, or the like, as opposed to woven. It is to be understood that other fabric constructions known in the art may be used.

Referring now to FIGS. 3A and 3B, the figures show a cross-sectional portion in a critical zone 11 of an embodiment of the gown 10. More specifically, the figures show the coated, two-ply barrier fabric 12 from which the selected portion of the gown 10 is constructed. The fabric 12 is comprised of two plies 44 and 46, i.e., a first ply 44 of woven material and a second ply 46 of woven material with each ply having a coating 42 thereon. Together, the two plies 44, 46 define an interior 48 of the fabric 12 and an exterior 50 of the fabric 12. The interior 48 of the fabric 12 is the region between the first ply 44 and the second ply 46 that is generally shielded from the surrounding environment by virtue of the two-ply construction of the fabric 12. The exterior 50 of the fabric 12 is the region on opposing sides of the first and second plies 44, 46 that is exposed to the surrounding environment.

With continuing reference to FIGS. 3A and 3B, the second ply 46 of the two-ply barrier fabric 12 is rotated relative to the first ply 44 such that the warp (or machine) direction of the second ply 46, here the warp yarns 38 of the second ply 46, are situated perpendicular (i.e., at a 90-degree rotation) to the warp (or machine) direction of the first ply 44, here the warp yarns 38 of the first ply 44, to provide a crisscross type configuration. It should be understood that the fill (or cross-machine) direction of the second ply 46, here the fill yarns 40 of the second ply 46, also are at a 90-degree orientation relative to the fill (or cross-machine) direction of the first ply 44, here the fill yarns 40 of the first ply 44. This orientation of the warp yarns 38 improves the overall tear strength of the barrier fabric 12 relative to a parallel orientation of the warp yarns 38, for example, thereby allowing the reusable surgical gown 10 to withstand up to 50 or more industrial wash/dry/autoclave cycles. In another example, the reusable surgical gown 10 can withstand up to 60 or more industrial wash/dry/autoclave cycles. In another example, the reusable surgical gown 10 can withstand up to 100 or more industrial wash/dry/autoclave cycles.

Regardless of how the barrier fabric 12 is produced (e.g., woven, knitted, non-woven, etc.), in an embodiment, the content of the yarn/fiber that makes up the fabric 12 can be 25% or more polyester or polyamide, such as filament polyester or polyamide. In one example, the filament is multifilament yarn. In one example, the yarn (or fiber content) can include synthetic filament or staple fiber. The yarn/fiber content of one ply 44, 46 may include polyester and the yarn of the other ply 44, 46 may include polyamide, or, in another example, the yarns/fiber content of any one ply 44, 46 may include combinations of polyester and polyamide, or combination of multifilament and monofilament yarn. In an alternative embodiment, the content of the yarn/fiber content that makes up the barrier fabric 12 is up to 100% filament polyester or polyamide. Polyester or polyamide, such as nylon, may be chosen due to their material properties (e.g., lint generation performance, colorfastness, inherent hydrophobicity, etc.), wide availability, and cost. It is to be understood that other non-linting polymers or fibers could be used. Also, electrostatic dissipating yarns may be used in the barrier fabric 12. In one example, one or both plies 44, 46 can include from 1% to 10%, or from 1% to 5% electrostatic dissipating yarns. Electrostatic dissipating yarns can include graphene or other ESD materials in combination with non-ESD filaments such as polyester. In another example, one or both plies 44, 46 can include about 2.8% electrostatic dissipating yarns where the fabric contains a total of 0.04% graphene by weight. In one example, the ESD yarns, such as graphene yarns, can be approximately evenly distributed throughout the ply (ies), such as to define stripes. It is also understood that antimicrobial fibers or yarns or flame resistant (FR) fibers or yarns can be used.

Due to the perpendicular orientation of the warp yarns 38 of one ply 44, 46 relative to the other ply 44, 46, a desired tear strength for the barrier fabric 12 can be obtained and user comfort of the gown 10 can be maximined during use by minimizing the total gown weight such as by providing an unbalanced weave construction, which can be related to the number of warp ends per inch and the fill picks per inch. By weaving fewer fill picks per inch than warp ends per inch (or vice-versa), for example, the barrier fabric 12 can cost less to manufacture and still withstand up to 50 or more industrial wash/dry/autoclave cycles. In one example, the plies 44, 46 of the barrier fabric 12 can include 30 denier 100% polyester multi-filament yarn in both the warp and weft direction with 213 ends per inch (epi)×177 picks per inch (ppi). In another example, the plies 44, 46 of the barrier fabric 12 can include 25 denier 100% polyester multifilament yarn in both the warp and weft plus 20 denier ESD yarn in the weft with 218 epi×(174+14) ppi. In another example, the barrier fabric 12 can have one or both plies 44, 46 with 50 gsm of 100% polyester multi-filament yarn or 48 gsm of 3% electrostatic dissipating yarn/97% polyester multi-filament yarn. In one example, the difference between the epi and ppi can be 10% or more (See below Table 1, as one example of a first ply 44 and a second ply 46). In another example, the difference can be 10-50%, 10-30%, or 10-20% between the epi and ppi.

TABLE 1

| | Weight, | | | Warp/inch | Weft/inch | |
|---|---|---|---|---|---|---|
| Ply | gsm | Warp Yarn | Weft Yarn | (EPI) | (PPI) | Imbalance |
| First Ply | 50 | 30 denier PET | 30 denier PET | 213 | 177 | 16.9% |
| | | (Polyethylene | | | | |
| | | Terephthalate, | | | | |
| | | a polyester) | | | | |
| Second Ply | 48 | 25 denier PET | 25 denier PET + | 218 | 174 + 14 | 13.8% |
| | | | 20 denier ESD | | | |

In the above Table 1, the imbalance was determined as follows: (EPI−PPI)/EPI×100%≥10%. And coating weights (actual) were 11 g/m²+/−2 g/m² on each ply.

As can be seen in FIGS. 3A and 3B, only one side of each of the first and second plies 44, 46 is coated with a coating 42. The coated side of the first ply 44 and the coated side of the second ply 46 face each other in the interior 48 of the fabric 12. In this construction, the coating 42 on the first and second plies 44, 46 is not exposed to the environment. Instead, the coating 42 on the first and second plies 44, 46 is interiorly protected. Such a construction offers substantial advantages over other barrier fabrics known in the art. This coating-to-coating orientation diminishes abrasion to the coating material and extends product service life. Specifically, the useful life of the gown 10 (or other garment, drape, etc. the fabric 12 is used in) can be extended because the coating 42 is not exposed to outside or external elements, such as during the laundering/autoclave cycle, that typically lead to degradation of the coating 42 (and thus the loss of the “barrier” properties of the fabric). Further, the comfort and feel of the gown 10 (or other garment, drape, etc.) embodying the fabric 12 are improved as each or either ply of the product may have a coating weight that is lighter than has historically been the case. Additionally, a wearer of the gown 10, for example, is exposed to the non-coated (e.g., woven, knitted, etc.) sides of the fabric 12—thereby eliminating direct contact with the coating 42 materials by the wearer or user of a finished product (as in the case of some known reusable barrier fabrics). In one example, the wearer of the gown 10 is exposed only to a non-coated side(s) of the fabric 12. Generally, wearers disfavor the feeling of the coating 42 against their skin, especially for long periods of time (as can be the case with gowns 10 and other surgical or medical apparel in medical or surgical applications). As such, the fabric 12 as embodied in the gown 10 offers improved comfort and feel over other barrier fabrics known in the art. In alternative embodiments, only one of the two plies 44, 46 may feature a coating 42 on one side of a ply.

The material for the resulting coating 42 can be applied to one side of each of the first and second plies 44, 46 via conventional coating technologies to impart a solid, semi-solid, liquid, or vaporized (e.g., sublimation) chemistry to coat one side of the fabric 12, as is known in the industry. For example, the material for the coating 42 may be applied to the fabric 12 using a knife coat, spray coat, foam coat, pad-, kiss coat, or similar methodology. It will be understood that alternative methodologies, as generally known in the art, besides those specifically listed can be used to apply the material for the coating 42 to one side of each of the first and second plies 44, 46 of the fabric 12. Upon application, the material for the coating 42 can interact with the surface of the ply 44, 46 in any number of ways, as would be understood in the industry, to provide the coating 42. For example, the applied coating material can adhere to the surface of the ply 44, 46, and may form a layer thereover, such as by binding to surface fibers (e.g., via covalent and/or non-covalent bonds, etc.) or the coating material can become entrapped within the fibers of the ply 44, 46. Further, a combination of some of all of polymerization, bonding, and physical entrapment can be used to adhere the coating 42 to the plies 44, 46.

Further, when applying the material for the coating 42, it is desirable to limit the penetration of the coating 42 through the ply 44, 46. It is known in the industry that applying a coating to a side of one ply 44, 46 can result in an undesirable “bleed-through” effect in which the applied coating may penetrate therethrough and appear on the other side of the ply 44, 46. It will be understood that the term ‘coated’ as used herein excludes the bleed-through of the coating 42. It will also be understood that the term ‘non-coated’ is inclusive of the bleed-through of coating 42 material. For example, if a coating 42 is applied to one side of a ply 44, 46, then the side of the ply 44, 46 that the coating 42 was applied to would be considered ‘coated’; however, the opposing side of the ply 44, 46, to which a coating 42 was not applied, could be considered ‘non-coated’, even if it exhibits bleed through effects from the coating 42 on the opposing side of the ply 44, 46.

Still referring to FIGS. 3A and 3B, the material for the resulting coating 42 can be applied to the fabric in a single pass and dried or cured thereon. In one example, the material for the coating 42 can be applied in a single pass and single cure application. Here, the applied material for the coating 42 may be heated, as is known in the art, to desirably cure the applied material and form the coating 42 on each ply 44, 46, where cure time and temperature, for example, may be generally dependent upon the selected coating material. A single pass and single cure application of the coating 42 offers distinct advantages over a two (or more) pass and two (or more) cure application, as may be used with barrier fabrics known in the art. Specifically, a single pass and cure operation desirably provides cost and efficiency benefits over an application that requires additional passes and time for curing. Instead of two (or more passes), the material for the coating 42 can be applied to one side of the first or second ply 44, 46 in a single pass. This reduces production time and thereby reduces the cost of producing the coated fabric 12. Similarly, the coated fabric 12 can be cured in a single curing process as opposed to two (or more) cures—at least one for each application pass. This also reduces production time and thereby reduces the cost of producing the coated fabric 12. Such benefits translate to the ability to produce more coated fabrics 12 in a shorter amount of time without sacrificing the quality of the coating 42. Thus, the overall cost and the per use cost of the fabric 12 are reduced, making reusable medical products embodying the fabric 12 attractive alternatives to disposable barrier fabrics or other reusable barrier fabrics known in the art.

While the material for the coating 42 can be desirably applied to the fabric in a single pass and dried or cured thereon, alternatively, the material for the coating 42 also may be applied in more than one pass or include more than one cure application. Utilizing more than one pass may be advantageous for minimizing coating defects and/or total coating weight, for example. Further, each coating pass may be performed with a different coating material to impart various functionalities, as desired, to each formed coating layer independently, such as improved hand feel, flexibility, adhesion, or other desirable coating traits, or combinations thereof.

When the material for the coating 42 is applied to a ply (first or second ply 44, 46 of the fabric 12), the material for the coating 42 can be applied at a rate of from 1 grams per square meter (“g/m²”) to 75 g/m². More specifically, in one embodiment, the material for the coating 42 can be applied at a rate of from 10 g/m² to 65 g/m². In another embodiment, the material for the coating 42 can be applied at a rate of from 15 g/m² to 50 g/m². In another embodiment, the material for the coating 42 can be applied at a rate of from 15 g/m² to 35 g/m². In a further embodiment, the material for the coating 42 can be applied at a rate of from 20 g/m² to 30 g/m². Even more specifically, in an embodiment, the material for the coating 42 can be applied at a rate of approximately 1, 2, 3, 4, 5, 6, 7, 8, 9, 10, 11, 12, 13, 14, 15, 20, or 25 g/m². In one example, the material for the coating 42 can be applied at a rate of approximately 11 g/m². Further, in an embodiment, the total, cumulative weight of the resulting coating 42 across both the first ply 44 and second ply 46, combined, can be 100 g/m² or less. In another embodiment, the total, cumulative weight of the coating 42 across both the first ply 44 and second ply 46, combined, can be 75 g/m² or less. In yet another embodiment, the total, cumulative weight of the coating 42 across both the first ply 44 and second ply 46, combined, can be 50 g/m² or less. In still another embodiment, the total, cumulative weight of the coating 42 across both the first ply 44 and second ply 46, combined, can be 25 g/m² or less. And in still another embodiment, the total, cumulative weight of the coating 42 across both the first ply 44 and second ply 46, combined, can be from 20 to 25 g/m². For example, the coating 42 on the first and second plies 44, 46 may be 20 g/m² each—for a total of 40 g/m² across both plies 44, 46, and performed in a single pass. Alternatively, the coating rate on each ply 44, 46 may vary. For example, the coating 42 on the first ply 44 may be 20 g/m² and the coating 42 on the second ply 46 may be 25 g/m²—for a total of 45 g/m² across both plies 44, 46, and performed in a single pass. In another example, the coating 42 on the first and second plies 44, 46 may be 11 g/m² each—for a total of 22 g/m² across both plies 44, 46, and performed in a single pass.

Applying such a light coating 42 to the first and second plies 44, 46 of the fabric 12 results in plies 44, 46 with a desirable comfort and feel. Some known coated fabrics used in reusable medical products feature thick coatings. As such, these fabrics have an unpleasant rubber-like feel. Specifically, medical apparel made from such thickly coated fabrics are uncomfortable to wear, especially for long durations of time (such as during a medical procedure). In contrast, applying a light coating 42 on the first and second plies 44, 46 (as opposed to a thicker coating on a single ply) results in a finished fabric 12 that is similar in feel and comfort to an uncoated fabric, but with the desirable barrier properties of a coated fabric 12. As such, the fabric 12 achieves the desirable properties of a reusable barrier fabric without sacrificing on comfort or feel.

Still referring to FIGS. 3A and 3B, the material for the resulting coating 42 can include on or more monomers, prepolymers, or polymers (or combinations thereof). Monomers can react partially or fully to form a polymer by the application of heat, crosslinker, or other suitable driving force (a process called curing). Prepolymers may further react to form a different polymer through similar means. Therefore, after curing the coating material, a polymer is formed and the coating 42 is defined by or includes the as-formed polymer(s).

Suitable monomers, prepolymers, and polymers for forming the coating 42 include, but are not limited to, acrylic, polyurethane, silicone, waxes, polyolefins, dendrimers, or other similar materials, and can include thermosetting or thermoplastic polymers. In addition, the material for the coating 42 may optionally further be mixed with or include solvents, compatibilizing agents, wetting agents, penetrants, cross linkers, accelerators, chain extenders, colorants, antimicrobial agents, or other formulation additives known in the art such as to improve coating material processability, open time, pot life, quality, or desirability. The material for and the resulting coating 42 can be a fluorine free coating. In another example, the coating 42 can include no additional or intentionally added fluorine. Other known coated barrier fabrics often utilize chemical hydrophobic finishes containing fluorocarbons, such coatings are known to diminish in effectiveness through repeated processing and use cycles. To avoid such known issues with fluorine containing coatings, the material for the coating 42, in one example, may be selected from any of a variety of non-fluorine containing materials. For example, the coating material may be selected from any of a variety of non-fluorine containing monomers, prepolymers, or polymers such as acrylic, polyurethane, including thermoplastic polyurethane, silicone, or other similar materials. Further, the coating 42 may be composed of any combination or mixture of the above non-fluorine containing polymers. In one example, the coating is silicone. It will be understood that alternative fluorine free polymers bedsides those specifically listed can also be used for the coating 42. In one example, the coating may be selected based on a desired coefficient of friction, such that the coated and facing surfaces of the plies 44, 46 can move freely thereagainst and with little to no damage thereto. In one example, the material for the coating 42 may be selected based on a desired non-linting (peeling) and/or based on a desired non-tackiness, such as to avoid lint clinging thereto and/or an unpleasant feel thereof. It may also be understood that the coating may include antimicrobial, flame resistant (FR), or other additives.

Referring now specifically to FIG. 3A, the figure shows the coated, two-ply barrier fabric 12 from which the selected portion of the gown 10 is constructed with a gap 52 (not necessarily to scale) between the first ply 44 and the second ply 46 of the fabric 12 and wherein the warp yarns 38 of the second ply 46 are oriented perpendicular to the warp yarns 38 of the first ply 44. The presence of the gap 52 in the interior 48 of the fabric 12 signifies that the first ply 44 and second ply 46 are not adhered or bonded to each other in this embodiment. The first ply 44 and the second ply 46 still are joined about their peripheries by techniques known in the art, such as by sewing. However, the plies 44, 46 are not otherwise constrained with respect to each other. Specifically, the first ply 44 and the second ply 46 are free to move against each other in the interior 48 of the fabric 12. Accordingly, there are no additional plies or layers situated between the first and second plies 44, 46.

Because only the interior-facing sides of the first and second plies 44, 46 are coated, it is understood that the coating 42 of the first ply 44 will rub, but still move freely due to coating characteristics, against the coating 42 of the second ply 46. Such is preferable to the coated side of either ply being directly exposed to the outside or exterior environment. Coatings 42 are generally abraded and/or degraded when they come into contact with any number of environmental factors. For example, if the coated side of the ply were on the exterior 50 of the fabric 12 as opposed to the interior 48, then the coating 42 would be exposed during the institutional laundering/autoclave cycle where the coating 42 could be damaged by the harsh detergents, agitation during a washing phase, or heat during a drying phase. Such abuse could severely diminish the useful life of the fabric 12 as a barrier fabric by degrading the coating 42.

Still referring to FIG. 3A, the coated sides of each of the plies 44, 46 face the interior of the fabric 12, and each other. It is understood that the coating 42 is generally not abrasive or generally substantially detrimental to itself. As such, when the coated side of the first ply 44 and the coated side of the second ply 46 rubs or moves against each other in the interior 48 of the fabric 12, the contact should be generally non-abrasive or non-degrading, i.e., generally non-detrimental. That is to say that, in general, the coated sides of the plies 44, 46 are free to interact with each other without worry of detrimentally damaging the coatings 42 during the useful laundering life of the gown 10. In this way, the construction of the fabric 12 (e.g., with the coating 42 only on the interior-facing sides of the plies 44, 46) lends itself to exceptional durability, at least in comparison to some known reusable barrier fabrics, and does not detract from the useful life of the gown 10 or whatever product, apparel, or garment the fabric 12 is embodied in (e.g., a gown 10 or drape). Such is an advantage of the fabric 12 over reusable barrier fabrics known in the art.

Referring now specifically to FIG. 3B, the figure shows a cross-section of a portion of an embodiment of the gown 10, and more specifically and in contrast to FIG. 3A, the figure shows the coated, two-ply barrier fabric 12 from which the selected portion of the gown 10 is constructed with no gap 52 between the first ply 44 and the second ply 46 of the fabric 12 and again wherein the second ply 46 is rotated relative to the first ply 44 so that the warp yarns 38 of each ply 44, 46 are perpendicular to one another. And despite the absence of a physical gap 52 between the first ply 44 and the second ply 46, the plies 44, 46 are not adhered or bonded together. But rather, the plies 44, 46 are free to move against each other (e.g., in the transverse direction).

Referring generally to FIGS. 1-3B, at least some portions of the gown 10 are fabricated from a coated, two-ply barrier fabric 12 by means and methods known in the art. In one example, a single ply layer can be manufactured by known weaving, knitting, or nonwoven techniques and cut to form two ply layers 44, 46, for the gown 10 that can be sewn or stitched together by known techniques such that the warp yarns 38 of one ply 46 are perpendicular to the other ply 44. Alternatively, it should be appreciated that two separate plies 44, 46 could be manufactured by known weaving, knitting, or nonwoven techniques, for example, and sewn or stitched together by known techniques such that the warp yarns 38 of one ply 46 are perpendicular to the other ply 44. The two-ply construction of the fabric 12 offers advantages of other reusable barrier fabrics known in the art. Specifically, the fabric 12 offers redundancy in the form of two plies 44, 46 that each comprise a coated side. The redundancy of having each of the two plies 44, 46 coated on one side provides for a more reliable fabric 12 with a longer useful life than other coated barrier fabrics known in the art. Further to that end, it is a feature of the fabric 12 to exhibit excellent barrier fabric properties as well as improved tear strength due, in part, to the rotated orientation of one ply 44, 46 relative to the other ply 44, 46, which allows for a reduced manufacturing costs due to the availability of an unbalanced weave construction, as discussed hereinabove.

In one example, the two-ply configuration of the fabric 12 results in a higher hydrostatic resistance than either of the two plies 44, 46 would yield individually or would be yielded by the same total coating weight applied to a single ply. In one embodiment, a finished garment (e.g., gown 10) or drape fabricated from the fabric 12 will test at not less than 20 cm of hydrostatic resistance within a critical zone 11 of the respective gown 10 or drape when tested pursuant to the American Association of Textile Chemists and Colorists (“AATCC”) 127 hydrostatic pressure standardized test method. Similarly, in another embodiment, a finished garment (e.g., gown 10) or drape fabricated from the fabric 12 will test at not more than 1 gram of penetration within a critical zone 11 of the respective gown 10 or drape when tested pursuant to the AATCC 42 impact penetration standardized test method. In other words, in an embodiment, a finished garment (e.g., gown 10) or drape fabricated from the fabric 12 will conform to at least minimum standards established for Level 2 classification by the AAMI PB70 Standard. Additionally, in an embodiment a finished garment (e.g., gown 10) or drape fabricated from the fabric 12 will maintain the above described hydrostatic resistance and impact penetration performance after at least ten institutional laundering/autoclave cycles and reliably for the full anticipated institutional service life prescribed by the manufacturer, which may significantly exceed ten cycles.

In one embodiment, a finished garment (e.g., gown 10) or drape fabricated from the fabric 12 will test at not less than 50 cm of hydrostatic resistance within a critical zone 11 of the respective gown 10 or drape when tested pursuant to the American Association of Textile Chemists and Colorists (“AATCC”) 127 hydrostatic pressure standardized test method. Similarly, in another embodiment, a finished garment (e.g., gown 10) or drape fabricated from the fabric 12 will test at not more than 1 gram of penetration within a critical zone 11 of the respective gown 10 or drape when tested pursuant to the AATCC 42 impact penetration standardized test method. In other words, in an embodiment, a finished garment (e.g., gown 10) or drape fabricated from the fabric 12 will conform to at least minimum standards established for Level 3 classification by the AAMI PB70 Standard. Additionally, in an embodiment a finished garment (e.g., gown 10) or drape fabricated from the fabric 12 will maintain the above described hydrostatic resistance and impact penetration performance after at least ten institutional laundering/autoclave cycles and reliably for the full anticipated institutional service life prescribed by the manufacturer, which may significantly exceed ten cycles

Advantageously, the coated, two-ply barrier fabric 12 described herein avoids problems of other barrier fabrics known in the art. For example, the two-ply construction of the fabric 12, where the coated side of the first ply 44 and coated side of the second ply 46 are interior 48 facing, enhances the durability of the fabric 12. By protecting the coating 42 from environmental factors (e.g., institutional laundering/autoclave cycles) the useful life of the fabric 12 is extended. Other known barrier fabrics often utilize chemical hydrophobic finishes, containing fluorocarbons, that are known to diminish through repeated processing and use cycles. Leaving the coating exposed can drastically reduce the lifespan of the barrier fabric. Furthermore, the construction of the fabric 12 offers a more reliable barrier without sacrificing the feel of the fabric 12. By utilizing two plies 44, 46 with thin coatings 42, the fabric 12 can achieve the barrier properties of a fabric with a much thicker coating without compromising on the feel of the fabric. Whereas fabrics known in the art with thicker coatings typically have an uncomfortable, undesirable rubber-like feel, the fabric 12 described above maintains the feel and comfort of an uncoated fabric because the coated sides of the plies 44, 46 are not exposed to a user or wearer. Moreover, the two coated plies 44, 46 of the fabric 12 offer a barrier redundancy not offered by coated barrier fabrics known in the art. The two-ply configuration of the fabric 12 yields a higher hydrostatic resistance than either of the two plies 44, 46 would yield individually or would be yielded by a single layer or ply that was coated with the same quantity of coating 42 utilized cumulatively for the two individual plies 44, 46.

Still further, the rotated orientation of the first ply 44 relative to the second ply 46 so that the warp yarns 38 in the plies 44, 46 are perpendicular to one another provides the barrier fabric 12 with an improved or more desirable tear strength as compared to the warp yarns being not rotated at all, i.e., simply positioned parallel with one another as is generally known in the art. This 90-degree rotations allows the reusable gown 10 to withstand up to 50 or more industrial wash/dry/autoclave cycles. Thus, the useful life of the reusable gown 10 including the barrier fabric 12 can be extended.

By way of experimentation, through a series of wash, dry, and autoclave (w/d/a) tear testing experiments, it was determined that a single ply of barrier fabric 12 seemingly always had a strong and weak direction. That is, the tear strength of a single ply was greater in one direction relative to the opposite orientation/direction and this trend continued w/d/a cycle after cycle. In view of that, it was hypothesized that in a 2-ply construction, one ply 46 of barrier fabric could be rotated 90 degrees relative to the second ply 44 (e.g., the warp yarns 38 of one ply 46 could be oriented perpendicular to the warp yarns 38 of another ply 44) and through mechanical averaging the resulting tear (and tensile) strength would be more consistent regardless of fabric direction. Such orientation/90-degree rotation of one ply 44 relative to the other ply 46 is atypical due, in part, to unfavorable circumstances that can result concerning undesirable shrinkage and other factors. Wash/dry/autoclave cycle tear strength testing proved this to be the case. In particular, to evaluate the overall improvement, particularly the overall tear strength improvement, two plies of barrier fabric were sewn together with and without the 90-degree rotation/orientation of the warp yarns, and swatches thereof subjected to wash, dry, and autoclave cycles w/d/a with tear strength being tested thereafter. High temperatures (e.g., 248° F. and greater, more preferably at or above 325° F.) used during dyeing, finishing, and/or curing of the barrier fabric 12 can be used to heat set the barrier fabric 12 so it can be used crisscross without undesirable shrinkage/puckering of the two plies 44, 46 relative to each other.

With these experiments, both the single ply (strong and weak direction) testing and the two ply barrier fabric (with and without 90-degree orientation) testing was conducted. For example, a swatch of barrier fabric having one ply composed of 50 gsm fabric that was 100% polyester 30 denier/72 filament yarns in both warp and weft, 213 threads/inch in the warp, 177 threads/inch in the weft, of plain weave and with 11 gsm silicone coating (for single ply testing, referred to as RMH00010 in the examples/samples below), and, for two ply barrier fabric testing, a swatch of barrier fabric having one ply including the same aforementioned single ply layer and the other ply (referred to as RMH00011 in the examples/samples below) including 48 gsm fabric that was 99.96% polyester and 0.04% graphene, and in the warp included 25 denier/72 filament yarns, with 218 warp threads/inch and 25 denier/72 filament weft yarns at 174 weft threads/inch, and also having 20 denier/3 filament graphene ESD yarns at 14 weft threads per inch, in a plain weave with 11 gsm silicone coating were subjected to experimentation as follows. In particular, each swatch was subjected to w/d/a cycling as set forth in Table 2 and further discussed hereinbelow. It is noted that each swatch was mechanically agitated in the various baths.

TABLE 2

| | | Duration | Temperature | | Extraction |
|---|---|---|---|---|---|
| Step | Operation | (minutes) | (° F.) | Chemistry Added | (RPM) |
| 1 | Flush | 2 | 110 | — | — |
| 2 | Break | 7 | 160 | Alkali - pH 10.5 (approx. 2.08 oz) | — |
| 3 | Suds | 5-7 | 160 | Detergent 1.46 oz | — |
| 4 | Rinse | 2 | 140 | — | — |
| 5 | Rinse | 2 | 120 | — | — |
| 6 | Bleach | 3 | 110 | 1.04 oz @ 33% | |
| 7 | Extraction | 1 | — | — | 200 |
| 8 | Rinse | 2 | 90 | — | — |
| 9 | Sour | 5 | 100 | Sour pH 6 (approx. 1.88 oz) | — |
| 10 | Rinse | 2 | 140 | — | — |
| 11 | Extraction | 6 | — | — | 840 |
| 12 | Dry | 30 | 160 | — | — |
| 13 | Cool down | 5 | 100 | — | — |
| 14 | Prevacuum Steam sterilization | 4 | 270 | — | — |
| 15 | Sterilization Dry | 15 | — | — | — |

As indicated above in Table 2, each swatch initially was flushed with water at 110° F. for two minutes (Step 1) followed by an alkali bath (pH 10.5) at approximately 160° F. for seven minutes (Step 2). Next, the swatch was placed in a detergent bath at approximately 160° F. for approximately five minutes (Step 3). This is followed by multiple rinsings over 4 minutes at temperatures that were progressively reduced from about 140° F. to 120° F. (Steps 4-5). The swatch was then exposed to a bath with bleaching agent at 110° F. for 3 minutes (Step 6) and was extracted to remove water (Step 7) after which the swatch was rinsed for 2 minutes at 90° F. (Step 8), placed in a sour bath at pH 6 for 5 minutes (Step 9), and then placed in a final rinse at 140° F. for 2 minutes (Step 10). After washing, the swatch was extracted to remove as much water as possible prior to drying (Step 11), then dried in a tumbling dryer at an average temperature of 160° F. for 30 minutes (Step 12). The swatch was cooled down at 100° F. for 5 minutes (Step 13). After drying and cool down, the swatch was placed in an autoclave and sterilized by pressurized steam at a temperature of approximately 270° F. for four minutes in a commercially available pre-vacuum steam sterilizer (Step 14), and finally subjected to sterilization drying for 15 minutes (Step 15), during which the sterilizer purges the steam using dry air at 270° F., then applies vacuum thereto while allowing the temperature to be reduced from 270° F. to below 200° F., after finally equalizing pressure to near ambient to facilitate drying. Tear strength was determined initially and after wash, dry, autoclave cycles in accordance with ASTM D 5587-14, “Standard Test Method for Tearing Strength of Fabrics by Trapezoid Procedure”.

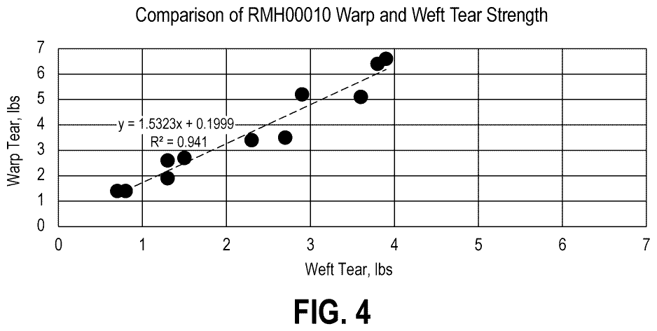

For the single ply barrier fabric, which was subjected to the w/d/a cycling as set forth in Table 2, the tear in warp direction was stronger than the weft direction. Tear results in both directions were measured after specified wash/dry/autoclave cycles for multiple samples (samples 1-3, RMH00010) and are summarized in Table 3 below with a resulting average percent difference of weft to warp tear strength of 39%. The composition of the single ply fabric was as described above, i.e., 50 gsm, 100% polyester plain weave fabric containing 30 denier/72 filament warp at 213 ends/inch and weft 177 wefts per inch, which results in a 16.9% EPI/PPI imbalance. The resulting slope as shown in the graph of FIG. 4, equal to 1.5, illustrates the relationship between warp and weft tear strength, which is not 1 to 1. Furthermore, the 16.9% fabric imbalance resulted in 39% tear strength difference.

TABLE 3

| | | # Wash-Dry- | | | % Difference in | |
|---|---|---|---|---|---|---|
| | Wash | Autoclave | Weft Tear, | Warp Tear, | Warp vs Weft | Average |
| Sample ID | condition | cycles | lbs | lbs | Tear Strength | Tear, lbs |
| RMH00010 | WDA | 1 | 3.9 | 6.6 | 41% | 5.3 |
| Lot 1 | WDA | 10 | 2.9 | 5.2 | 44% | 4.1 |
| | WDA | 25 | 2.3 | 3.4 | 32% | 2.9 |
| | WDA | 50 | 1.3 | 2.6 | 50% | 2.0 |
| | WDA | 75 | 0.7 | 1.4 | 50% | 1.1 |
| RMH00010 | WDA | 1 | 3.6 | 5.1 | 29% | 4.4 |
| Lot 2 | WDA | 50 | 1.5 | 2.7 | 44% | 2.1 |
| | WDA | 75 | 0.8 | 1.4 | 43% | 1.1 |
| RMH00010 | WDA | 1 | 3.8 | 6.4 | 41% | 5.1 |
| Lot 3 | WDA | 50 | 2.7 | 3.5 | 23% | 3.1 |
| | WDA | 75 | 1.3 | 1.9 | 32% | 1.6 |
| | | | | Average | 39% | |

For the two ply barrier fabric testing, four different samples (See Table 4 below) were subjected to the w/d/a cycling as set forth in Table 2 and evaluated accordingly with the results summarized in Tables 5-8 below. The two varied parameters in the samples were the composition of the fabric plies, i.e., RMH00010 (a 100% polyester fabric ply) compared to RMH00011 (an ESD yarn-containing fabric ply), and the orientation of the fabric plies relative to each other, i.e., parallel warp directions or 90-degree orientation of each ply's warp direction.

TABLE 4

| Sample ID | Ply | Fabric Ply #1 | Fabric Ply #2 | Orientation |
|---|---|---|---|---|
| RMH00020 | 2 | RMH00010 | RMH00010 | Parallel |
| RMH00021 | 2 | RMH00010 | RMH00010 | 90 Degree |
| RMH00030 | 2 | RMH00010 | RMH00011 | Parallel |
| RMH00031 | 2 | RMH00010 | RMH00011 | 90 Degree |

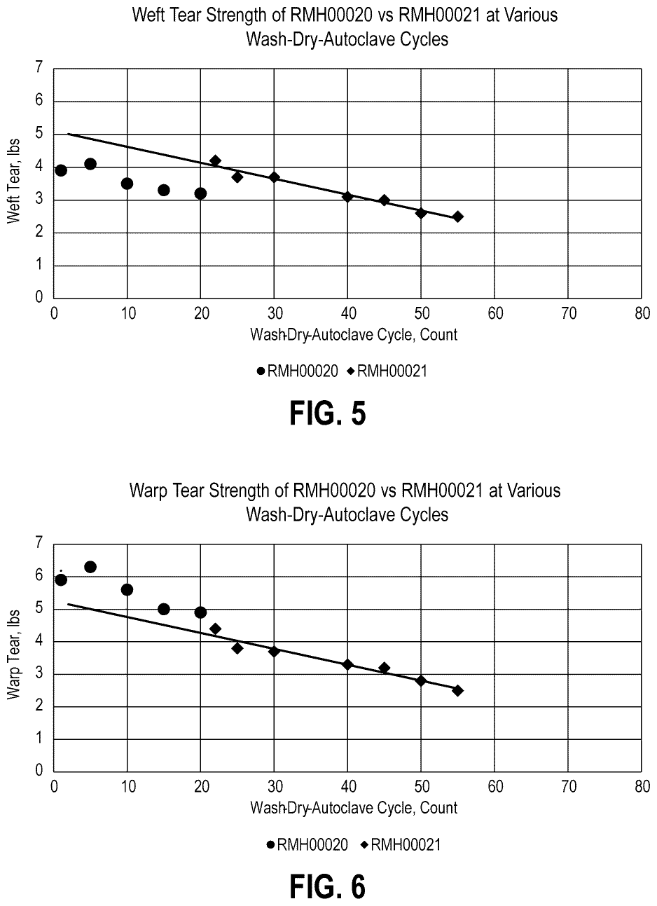

As shown in Table 5, the RMH00020 2-ply barrier fabric sample, which was composed of RMH00010 with 16.9% imbalance in yarn density, averaged 35% difference in warp and weft tear strength. However, as shown in Table 6, changing the 2-ply orientation (See RMH00021) resulted in only a 4% difference in warp and weft tear strength. The increased weft tear strength was achieved in RMH00021 without significantly altering the warp tear strength of RMH00021. The 90-degree rotation increased the weft tear strength of RMH00021 compared to RMH00020 as visually illustrated in the graphs of FIGS. 5 and 6. Indeed, comparing the weak and strong direction of physically coupled layers with 90-degree rotation illustrated a mechanical averaging effect and a resulting balanced strength, which exceeded an acceptable tear strength of approximately ≥2.3 pounds at 60 w/d/a cycles and beyond.

TABLE 5

| | # Wash- | | | % Difference | |
|---|---|---|---|---|---|
| | Dry- | Weft | Warp | in Warp | |
| | Autoclave | Tear, | Tear, | vs Weft Tear | Average |
| Sample ID | cycles | lbs | lbs | Strength | Tear |
| RMH00020 | 1 | 3.9 | 5.9 | 34% | 4.9 |
| RMH00020 | 5 | 4.1 | 6.3 | 35% | 5.2 |
| RMH00020 | 10 | 3.5 | 5.6 | 38% | 4.6 |
| RMH00020 | 15 | 3.3 | 5 | 34% | 4.2 |
| RMH00020 | 20 | 3.2 | 4.9 | 35% | 4.1 |
| | | | Average | 35% | |

TABLE 6

| | # Wash- | | | % Difference | |
|---|---|---|---|---|---|
| | Dry- | Weft | Warp | in Warp | |
| | Autoclave | Tear, | Tear, | vs Weft Tear | Average |
| Sample ID | cycles | lbs | lbs | Strength | Tear |
| RMH00021 | 22 | 4.2 | 4.4 | 5% | 4.3 |
| RMH00021 | 25 | 3.7 | 3.8 | 3% | 3.8 |
| RMH00021 | 30 | 3.7 | 3.7 | 0% | 3.7 |
| RMH00021 | 40 | 3.1 | 3.3 | 6% | 3.2 |
| RMH00021 | 45 | 3 | 3.2 | 6% | 3.1 |
| RMH00021 | 50 | 2.6 | 2.8 | 7% | 2.7 |
| RMH00021 | 55 | 2.5 | 2.5 | 0% | 2.5 |
| | | | Average | 4% | |

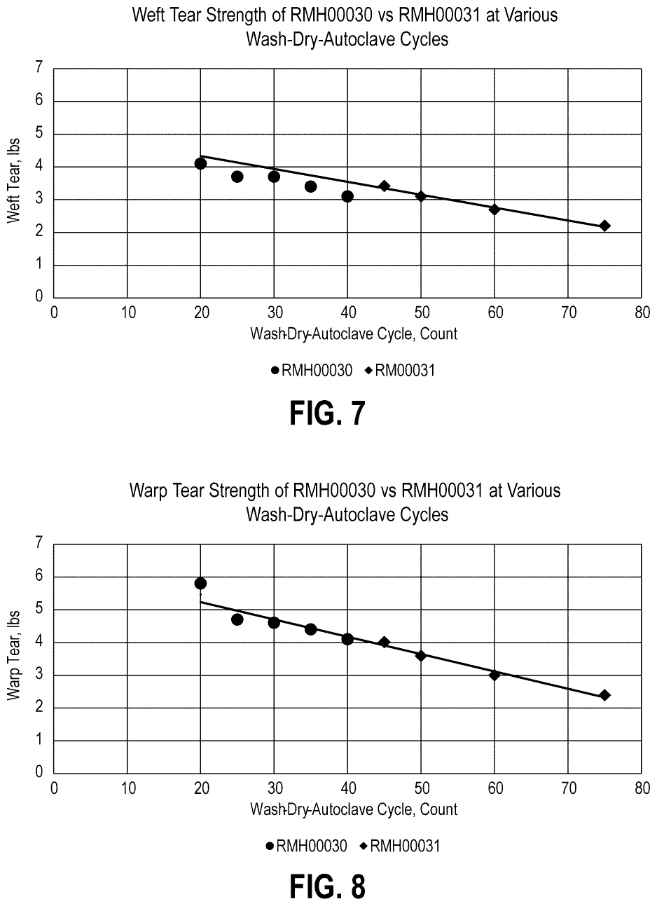

The second group of barrier fabrics evaluated (from Table 4) was RMH00030 (parallel orientation non-ESD and ESD containing fabrics) vs RMH00031 (90-degree rotation non-ESD and ESD containing fabrics). RMH00010 had a yarn density imbalance of 16.9% while RMH00011 had a yarn density imbalance of 13.8%. As shown in Table 7, RMH00030 averaged 23% difference between warp and weft tear strength. As shown in Table 8, changing the 2-ply barrier fabric orientation to 90 degrees in RMH00031 resulted in an average of 12% difference in warp and weft tear strength. The reduction in imbalanced tear strength was mostly due to increasing the weft tear strength, and the increased weft tear strength was achieved with virtually no deterioration of the warp tear strength (See graphs of FIGS. 7 and 8). Indeed, comparing the weak and strong direction of physically coupled layers with 90-degree rotation illustrated a mechanical averaging effect and a resulting balanced strength, which exceeded an acceptable tear strength of approximately ≥2.3 pounds at 60 w/d/a cycles and beyond.

TABLE 7

| | # Wash- | | | % Difference | |
|---|---|---|---|---|---|
| | Dry- | Weft | Warp | in Warp | |
| | Autoclave | Tear, | Tear, | vs Weft Tear | Average |
| Sample ID | cycles | lbs | lbs | Strength | Tear |
| RMH00030 | 20 | 4.1 | 5.8 | 29% | 5.0 |
| RMH00030 | 25 | 3.7 | 4.7 | 21% | 4.2 |
| RMH00030 | 30 | 3.7 | 4.6 | 20% | 4.2 |
| RMH00030 | 35 | 3.4 | 4.4 | 23% | 3.9 |
| RMH00030 | 40 | 3.1 | 4.1 | 24% | 3.6 |
| | | | Average | 23% | |

TABLE 8

| | # Wash- | | | % Difference | |
|---|---|---|---|---|---|
| | Dry- | Weft | Warp | in Warp | |
| | Autoclave | Tear, | Tear, | vs Weft Tear | Average |
| Sample ID | cycles | lbs | lbs | Strength | Tear |
| RMH00031 | 45 | 3.4 | 4.0 | 15% | 3.7 |
| RMH00031 | 50 | 3.1 | 3.6 | 14% | 3.3 |
| RMH00031 | 60 | 2.7 | 3.0 | 10% | 2.9 |
| RMH00031 | 75 | 2.2 | 2.4 | 8% | 2.3 |
| | | | Average | 12% | |

These, other features, and combinations thereof (as described in the preceding paragraphs) improve upon the shortcomings of reusable barrier fabrics known in the art. Other advantages and technical effects of the embodiments of this invention will become evident to one skilled in the art from the preceding description.

Although the above surgical gown 10 has been described above where the coated sides of each of the plies 44, 46 face the interior of the barrier fabric 12, and each other, it should be appreciated that one or both of the plies 44, 46 may have its coated side on the opposing side of either of the plies 44, 46. That is, in an embodiment, the coated side of one or both of the plies 44, 46 is on the exterior of the fabric 12 and, thus, faces away from the other ply (not shown). To that end, in one example, the wearer of the gown 10 may be exposed to the coating 42 on one side of the fabric 12 and/or the coating 42 may be exposed to outside or external elements. Yet, even with this configuration, the barrier fabric 12 can be provided with improved tear strength due to a crisscross orientation of the yarns 38.

In the end, the coating and/or coating process can impart a desirable stability to the barrier fabric 12 such that the machine direction (warp) shrinkage and cross machine (weft) shrinkage are sufficiently similar. This enables a 2-ply crisscrossed fabric that is peripherally joined together to avoid significant negative puckering, twisting, and unsightly appearance.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

1. A barrier fabric comprising:
a first ply and a second ply each comprising a coated side and a non-coated side,
wherein the first ply and the second ply are peripherally joined together to form the barrier fabric, and
wherein a machine direction of the first ply or second ply is rotated 90 degrees relative to a machine direction of the other ply to define a perpendicular orientation with respect to the yarns or fiber content in the first and second plies and provide a crisscross type configuration.

2. The fabric of claim 1, wherein the first ply is non-woven, woven, or knitted and the second ply is non-woven, woven, or knitted.

3. The fabric of claim 2, wherein the first ply is woven or knitted and the second ply is woven or knitted and the yarns used to weave or knit the first ply and the second ply include synthetic filament or staple fiber.

4. The fabric of claim 1, wherein the content of yarn or fiber of the first and second ply comprise approximately 100% polyester or approximately 100% polyamide.

5. The fabric of claim 1, wherein the coated side of the first ply and the coated side of the second ply each comprise a coating applied at a rate of from 1 g/m² to 75 g/m².

6. The fabric of claim 1, wherein the combined coating of the coated side of the first ply and the coated side of the second ply is applied at a rate of no more than 100 g/m².

7. The fabric of claim 1, wherein the coated side of the first ply and the coated side of the second ply comprise a coating applied at a rate of approximately 25 g/m².

8. The fabric of claim 1, wherein the coated side of the first ply and the coated side of the second ply comprise a non-fluorine containing polymer.

9. The fabric of claim 8, wherein the non-fluorine containing polymer is silicone applied at a rate of from 9 g/m² to 50 g/m², and wherein the yarn or fiber content of the first and second plies comprise at least 25% polyester or at least 25% polyamide.

10. The fabric of claim 1, wherein the coated side of the first ply and the coated side of the second ply is coated with a coating that excludes fluorine.

11. The fabric of claim 1, wherein the first ply and/or second ply is woven and includes either less fill picks per inch or warp ends per inch to provide an imbalance in yarn density.

12. The fabric of claim 1, wherein the first ply and second ply are woven and the first ply or second ply is rotated 90 degrees relative to the other ply to define a perpendicular orientation with respect to the warp yarns in the first and second plies to provide the crisscross type configuration.

13. The fabric of claim 1, wherein the coated side of the first ply and the coated side of the second ply face each other and define an interior of the barrier fabric, with each coated side able to come into direct contact with one another but remain movable thereagainst and able to form a gap therebetween, and
wherein the non-coated side of the first ply and the non-coated side of the second ply face opposing directions and define an exterior of the barrier fabric.

14. A reusable personal protective equipment product comprising:
a two-ply barrier fabric, the fabric including a first ply and a second ply each comprising a coated side and a non-coated side,
wherein the first ply and the second ply are peripherally joined together to form the barrier fabric, and
wherein a machine direction of the first ply or second ply is rotated 90 degrees relative to a machine direction of the other ply to define a perpendicular orientation with respect to the yarns or fiber content in the first and second plies and provide a crisscross type configuration.

15. The reusable personal protective equipment product of claim 14, wherein barrier performance of the personal protective equipment product meets a hydrostatic resistance and impact penetration performance through at least 50 institutional laundering/autoclave cycles.

16. The reusable personal protective equipment product of claim 14, wherein the reusable personal protective equipment product is a surgical gown, an isolation gown, or a surgical drape.

17. The reusable personal protective equipment product of claim 14, wherein the coated side of the first ply and the coated side of the second ply comprise a coating applied at a rate of from 1 g/m² to 75 g/m².

18. The reusable personal protective equipment product of claim 14, wherein the coated side of the first ply and the coated side of the second ply comprise a non-fluorine containing polymer.

19. The reusable personal protective equipment product of claim 14 wherein the coated side of the first ply and the coated side of the second ply face each other and define an interior of the barrier fabric, with each coated side able to come into direct contact with one another but remain movable thereagainst and able to form a gap therebetween, and
wherein the non-coated side of the first ply and the non-coated side of the second ply face opposing directions and define an exterior of the barrier fabric.

20. A method for making a two-ply barrier fabric for use in a reusable personal protective equipment product, the method comprising:
applying, via at least one pass, a non-fluorine containing pre-polymer, polymer, or monomer coating material to a side of each of two separate plies of a non-woven, woven, or knitted fabric, wherein the coating is applied at a rate of from 1 g/m² to 75 g/m²;
curing the coating on the fabric; and
peripherally joining together the coated first ply and second ply to form the barrier fabric,
wherein a machine direction of the first ply or second ply is rotated 90 degrees relative to machine direction of the other ply to define a perpendicular orientation with respect to the yarns or fiber content in the first and second plies and provide a crisscross type configuration; and
wherein the barrier fabric is suitable for use within or as a reusable personal protective equipment product.

21. The method of claim 20, wherein the reusable personal protective equipment product is a surgical gown, an isolation gown, or a surgical drape.

22. The method of claim 20, wherein the coating is applied at a rate of from 9 g/m² to 50 g/m², and the cured coating is silicone.

23. The method of claim 20, wherein barrier performance of the barrier fabric meets a hydrostatic resistance and impact penetration performance through at least 50 institutional laundering/autoclave cycles.

24. The method of claim 20 wherein the coated side of the first ply and the coated side of the second ply face each other and define an interior of the barrier fabric, with each coated side able to come into direct contact with one another but remain movable thereagainst and able to form a gap therebetween, and
wherein the non-coated side of the first ply and the non-coated side of the second ply face opposing directions and define an exterior of the barrier fabric.
